(19) United States
(12) Patent Application Publication
(10) Pub. No.: US 2021/0274752 A1
(43) Pub. Date: Sep. 9, 2021

(54) METHOD AND APPARATUS FOR DOG BEHAVIOR CONTROL

(71) Applicant: SCOTT LOUIS ANDERSON, MIDDLEFIELD, CT (US)

(72) Inventor: SCOTT LOUIS ANDERSON, MIDDLEFIELD, CT (US)

(21) Appl. No.: 17/164,850

(22) Filed: Feb. 2, 2021

Related U.S. Application Data
(60) Provisional application No. 62/985,691, filed on Mar. 5, 2020.

(51) Int. Cl. A01K 15/02

(52) U.S. Cl. CPC A01K 15/02

(57) ABSTRACT

A method for stimulus control of a dog utilizing operant conditioning which includes the steps of providing apparatus for selectively generating a vibration; providing apparatus for positioning the apparatus for selectively generating a vibration against the dog's underbelly intermediate the front legs and the rear legs; providing apparatus for selectively causing the apparatus for selectively generating a vibration to vibrate to stimulate the dog to stop selected undesirable behavior; and preventing the apparatus from selectively generating a vibration when the dog is not behaving in an undesirable manner. The method facilitates the training of a dog utilizing operant conditioning to prevent behaviors selected from the group consisting of barking, chasing cars, leash pulling, biting, bullying, jumping, and digging.

### CROSS-REFERENCE TO RELATED APPLICATIONS

This application is a continuation of U.S. provisional patent application 62/985,691 filed Mar. 5, 2020.

### TECHNICAL FIELD

The present invention is generally directed to animal training methods and apparatus. More particularly, the present invention is directed to a dog behavior control device used to discourage the dog from unwanted behaviors such as. but not limited to, jumping, barking, biting, excessive pulling on leash, etc. For the purpose of description, this application will often refer to the animal as a dog. Those skilled in the art will recognize that the term “dog” as used herein is to include any quadruped or other animal, for example, a pet monkey.

The present invention utilizes stimulus control. As described in Wikipedia, “In behavioral psychology (or applied behavior analysis), stimulus control is a phenomenon in operant conditioning (also called contingency management) that occurs when an organism behaves in one way in the presence of a given stimulus and another way in its absence. A stimulus that modifies behavior in this manner is either a discriminative stimulus (Sd) or stimulus delta (S-delta). Stimulus-based control of behavior occurs when the presence or absence of an Sd or S-delta controls the performance of a particular behavior. For example, the presence of a stop sign (S-delta) at a traffic intersection alerts the driver to stop driving and increases the probability that “braking” behavior will occur. Such behavior is said to be emitted because it does not force the behavior to occur since stimulus control is a direct result of historical reinforcement contingencies, as opposed to reflexive behavior that is said to be elicited through respondent conditioning.

### BACKGROUND OF THE INVENTION

Various drawbacks exist for many types of existing behavior control and reduced or no pull dog walking devices on the market today designed to control a dog's behavior have various drawbacks. For example, a leash is marketed comprising of a loop that wraps around the dog's torso/stomach area which squeezes around the dogs most sensitive area of the stomach to inhibit pulling. As the dog pulls harder the loop gets tighter making it more and more uncomfortable. Thus, the dog is conditioned not to pull. This method or targeting the dog's sensitive and instinctually vulnerable area of the stomach is highly effective but at the same time very dangerous to the dog's internal organs.

Some embodiments include a stop to keep the loop from squeezing too tightly, however, the apparatus still imposes direct pressure on the stomach of the dog. This is particularly significant if the dog lunges out or jolts forward suddenly.

Another prior art method for behavior control or training a dog not to pull on the leash is through the use of a remote control. In one priorversion a pressure activated electric shock collar or combination tone/vibration/electric shock collar delivers a stimulus to the dog's neck as a deterrent for unwanted behavior. This device is also effective in training the dog not to pull or to stop unwanted behavior, but there are several drawbacks to each. One method uses a remote control used by the trainer to deliver an electric shock to the dog's neck as a stimulus. The shock effect is highly effective but considered inhumane because the potential for abuse by the user shocking the dog excessively and causing harm to the animal. The vibration is used as a stimulation to deter undesirable behavior. If not effective a shock may be applied if the vibration isn't enough to deter the dog. With this device metal prongs are used to pass through any thickness of dog hair on the neck and must touch the skin to make the electrical connection to deliver a shock. These prongs can easily cause harm to the dog's skin because of the constant rubbing aggravated by the very tight collar. The collar must be very tight on the dog's neck to work. There is a vibration only collar on the market that doesn't use prongs but there are several deficiencies with this method. First many dog breeds have a substantial amount of hair on the dog's neck dampening the vibration making it ineffective. Also, the dog is used to having collars and leashes pulling on their neck and are desensitized to mild stimulants like vibration on the neck.

The prior art includes many neck collars having vibration mechanisms attached to the collar. Such mechanisms and methods of modify a dog's behavior are much less effective than the apparatus and methods in accordance with the present invention.

From the above, it is therefore seen that there exists a need in the art to overcome the deficiencies and limitations described herein and above.

### SUMMARY OF THE INVENTION

The shortcomings of the prior art are overcome and additional advantages are provided through a method for stimulus control of a dog utilizing operant conditioning which includes the steps of providing apparatus for selectively generating a vibration; providing apparatus for positioning the apparatus for selectively generating a vibration against the dog's underbelly intermediate the front legs and the rear legs; providing apparatus for selectively causing the apparatus for selectively generating a vibration to vibrate to stimulate the dog to stop selected undesirable behavior; and preventing the apparatus from selectively generating a vibration when the dog is not behaving in an undesirable manner.

In some methods in accordance with the present invention the method for stimulus control of a dog utilizing operant conditioning includes behaviors selected from the group consisting of leash pulling, barking, chasing cars, biting, bullying, jumping, and digging.

The method for stimulus control of a dog utilizing operant conditioning may include a Bluetooth control or Wi-Fi control.

The method for stimulus control may include providing apparatus having one or more features selected from the group consisting of selectively variable amplitude, selectively variable frequency and selectively variable frequency.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. Although specific features of various exemplary embodiments of the invention may be shown in some drawings and not in others, this is for convenience only. In accordance with the principles of the invention, any feature of a drawing maybe referenced and/or claimed in combination with any feature of any other drawing.

The invention, however, both as to organization and method of practice, together with the further objects and advantages thereof, may best be understood by reference to the following description taken in connection with the accompanying drawings in which:

FIG. 1 is a view of a first dog A having a strap, on which a vibrator is mounted, extending around the torso of the dog just forward of the dog's hind legs.

FIG. 2 is a view of a second dog B having a strap, on which a vibrator is mounted, extending around the torso of the dog just behind of the dog's hind legs.

FIG. 3 is a view of one embodiment of the strap apparatus in accordance with the present.

FIG. 4 is a side view of one form of the vibrator in accordance with the present invention.

FIG. 5 is an end view of the vibrator shown in FIG. 4.

FIG. 6 is a view of one embodiment of the control for the vibrator.

### DETAILED DESCRIPTION

The stomach/chest area of a dog is highly sensitive, has less hair than other parts, and is instinctually a dog's vulnerable area. Hence when a dog rolls over and gives you his/her belly to rub it, it is the considered the highest form of trust and submission a dog can offer.

The Collins English Dictionary at www.collinsdictionary.com states “The underbelly of an animal or vehicle is the underneath part of it.” Throughout this document the term “underbelly” is to be construed as meaning the underneath part of the dogs's torso intermediate the front legs and the rear legs. That meaning is relied on and utilized herein to define the location at which a vibration stimulus is best positioned. More specifically, the location is the dog's underbelly.

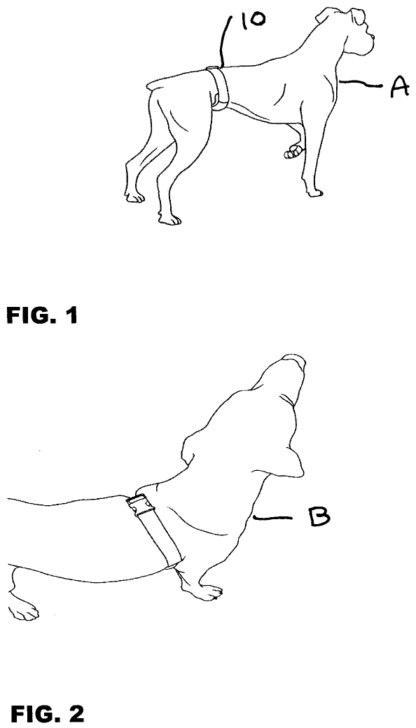

FIG. 1 is a view of a first dog A having a strap 10, on which a vibrator (not visible) is mounted, extending around the torso of the dog just forward of the dog's hind legs. FIG. 2 is a view of a second dog B having a strap 10, on which a vibrator FIG. 1 is a view of a first dog having a strap, on which a vibrator 12 is mounted, extending around the torso of the dog just forward of the dog's hind legs.

FIG. 2 is a view of a second dog having a strap 10, on which a vibrator 12 is mounted, extending around the torso of the dog just behind of the dog's hind legs. is mounted, extending around the torso of the dog just behind of the dog's hind legs. The vibrator 12 is not visible in FIGS. 1-2 because the vibrator 12 is disposed against the underbelly of each dog.

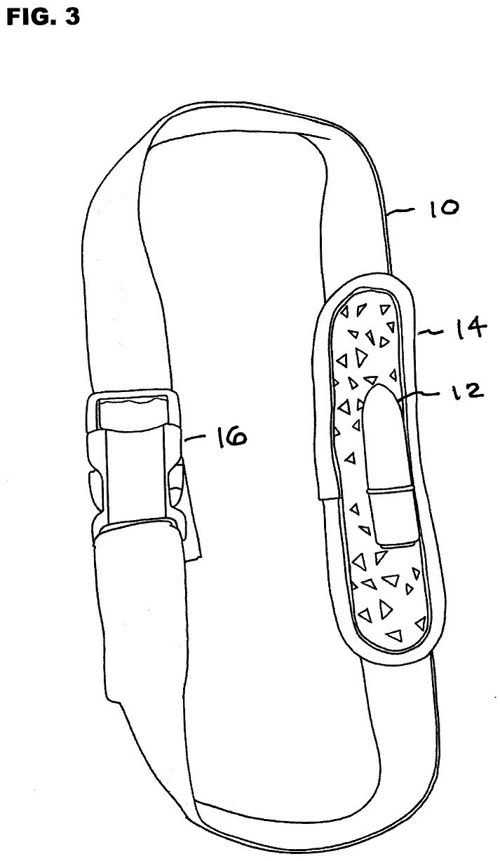

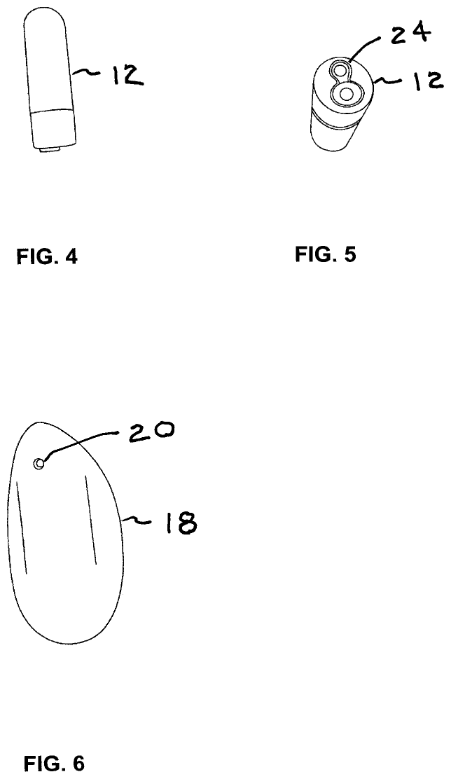

FIG. 3 is a view of one embodiment of the strap 10 apparatus in accordance with the present invention including a pocket 14 in which the vibrator is normally enclosed. For the purpose of illustration, the vibrator 12 is shown on top of a pocket 14. In use, the vibrator is secured within the pocket by hook and loop fastening means. In some embodiments at least the pocket is manufactured of silicone. That construction minimizes sliding along the dog's body. The strap includes a plastic belt clasp 16 which allows length adjustability of the strap 10 as well as quick positive connection and disconnection.

The vibrator 12 includes a rechargeable battery sufficient to operate a vibration apparatus. The rechargeable battery (not show) is charged through a port 24. In a conventional manner, the operation of the vibrator 12 may have a Bluetooth wireless connection to a control 18. In some embodiments, the control 18 includes a rechargeable battery (not shown) charges through a port 20. In the illustrated embodiment the control 18 is programmed to vibrate only when a button (not show) is depressed. This allows the necessary selectivity for the handler. Because such apparatus is available commercially addition specificity is not necessary. Persons skilled in the art will recognize the structure thereof. Other embodiments may use Wi-Fi to control the vibrator. Some embodiments may even use a smart phone application. The vibrator 12 audio capabilities which may be controlled by the control 18.

The present invention advantageously addresses the stigma and danger around causing pain to get the desired result of behavior control. By directing a mild vibration stimulus to the dogs most instinctually vulnerable area of the chest or stomach the dog complies to direction or commands with no pain necessary but still highly effective deterrent for unwanted behavior. By directing the vibration stimulus to the dog's chest or belly it is understood that delivering a painful deterrent like electric shock is not necessary to achieve the same desired effect and also that delivering a vibration only type stimulus to the dog's neck is nowhere close to the effectiveness of targeting the dog's torso rather than the neck. The present invention uses several methods to contain the vibration apparatus and target the chest or stomach area such as a comfortable elastic wrap or attached to a harness. Finally, there are many types of behavior control devices/apparatuses that are used today that either cause pain or psychological damage or are ineffective in comparison to the present invention. Applicant has not seen any product that directs a vibration stimulus to a dog's underbelly.

In one embodiment of the present invention, the dog owner/handler utilizes a remote control to operate the vibration stimulus which is attached to a comfortable elastic belt that easily attaches around the dog's torso holding the vibration device in the correct position.

The present apparatus is adjustable and suitable for any dog. In a first embodiment, a strap assembly is easily and quickly wrapped around the dog's torso so that the strap assembly passes over the dog's underbelly intermediate the front legs and the rear legs and holds the vibration device directly to the underside of the dog's torso to deliver a vibration stimulus controlled by a handler to deter unwanted behavior.

The dog instinctively protects the underbelly intermediate the front legs and the rear legs and will typically stop whatever the dog is doing to address the perceived danger to the dog's stomach or chest area. This approach advantageously benefits from the dog's inherent instincts. Accordingly, the present method and apparatus are more effective than other methods/devices currently on the market. In summary, the vibration stimulus on the dog's underbelly is highly effective, causes no pain or possibility of abuse, and is novel to anyone in the dog training device market. The vibration stimulus will also possibly include variations in vibration level and vibration types (pulse versus continuous) to further its effectiveness by being able to apply different levels and types of vibrations to change things up in case the dog becomes accustomed to one type or level of vibration. Finally, the dog learns what behaviors are unacceptable to the handler and will stop such behaviors. For example, a dog that jumps on people is an unwanted behavior, the dog will learn very quickly that each time it jumps up on someone they get a vibration stimulus that instantly and instinctually makes them get back down on all four legs. They will learn not to jump on people. Another example of unwanted behavior is a dog pulling on leash. With the present method the device is activated anytime the dog is conducting an undesired behavior, when the dog stops such behavior the device is deactivated remotely. The dog learns the “sweet spot” where there is no vibration and in time will learn to avoid such behavior.

The present invention advantageously avoids the stigma and danger around causing pain to get the desired result of behavior control. By locating and directing a mild vibration stimulus to the dogs most instinctually vulnerable area of the chest or stomach the dog complies to direction or commands with no pain necessary but still highly effective deterrent for unwanted behavior. By directing the vibration stimulus to the dog's chest or belly it is understood that delivering a painful deterrent like electric shock is not necessary to achieve the same desired effect and also that delivering a vibration only type stimulus to the dog's neck is nowhere close to the effectiveness of targeting the dog's torso rather than the neck. Finally, there are many types of behavior control devices/apparatuses that are used today that either cause pain or psychological damage or are ineffective in comparison to the present invention and there are no products presently on the market that are able to attach and direct a stimulus remotely to the dog's underbelly intermediate the front legs and the rear legs.

In one embodiment of the present invention, the dog owner/handler utilizes a remote control to deliver the vibration stimulus which is attached to a comfortable elastic belt that easily attaches around the dog's torso holding the vibration device in the correct position.

Some embodiments have variable vibration characteristics. More particularly, as described at https://www.ccohs.ca/oshanswers/phys_agents/vibration/vibration_intro.html Any vibration has measurable quantities. How far (amplitude or intensity), and how fast (frequency) the object moves helps determine its vibrational characteristics. The terms used to describe this are:

### Frequency

A vibrating object moves back and forth from its normal stationary position. A complete cycle of vibration occurs when the object moves from one extreme position to the other extreme, and back again. The number of cycles that a vibrating object completes in one second is called frequency. The unit of frequency is hertz (Hz). One hertz equals one cycle per second.

Amplitude

A vibrating object moves to a certain maximum distance on either side of its stationary position. Amplitude is the distance from the stationary position to the extreme position on either side and is measured in meters (m). The intensity of vibration depends on amplitude.

Acceleration (Measure of Vibration Intensity)

The speed of a vibrating object varies from zero to a maximum during each cycle of vibration. It moves fastest as it passes through its natural stationary position to an extreme position. The vibrating object slows down as it approaches the extreme, where it stops and then moves in the opposite direction through the stationary position toward the other extreme. Speed of vibration is expressed in units of meters per second (m/s).

Acceleration is a measure of how quickly speed changes with time. The measure of acceleration is expressed in units of (meters per second) per second or meters per second squared (m/s²). The magnitude of acceleration changes from zero to a maximum during each cycle of vibration. It increases as the vibrating object moves further from its normal stationary position.

Embodiments of the present invention can selectively vary acceleration, amplitude, and frequency. The selection of preferred characteristics will be governed by the size of the dog, the breed, and the characteristics of the particular dog as determined with the benefit of prior experience.

The present apparatus is adjustable and suitable for any dog. In a first embodiment, a belt or wrap is easily and quickly wrapped around the dog's torso in either the chest or stomach area of the dog and holds the vibration device directly to the underside of the dog's torso for use in attaching and delivering the stimulus by the handler to deter unwanted behavior. The dog's instinct to protect the vulnerable area of the stomach is so high that typically the dog will stop whatever the dog is doing to address the perceived danger to their stomach area. This technique is highly effective but not practical to use in most unwanted behavior situations and can be dangerous to the handler because the dog will most likely turn to possibly bite the person delivering the stimulus. This technique of targeting and tapping into the dogs instincts is the principal behind this disclosures effectiveness over other methods/devices currently on the market. Simply, the vibration stimulus on the dog's underbelly intermediate the front legs and the rear legs is highly effective, causes no pain or presents no possibility of abuse, and is novel to anyone in the dog training device market. The vibration stimulus will also possibly include variations in vibration level and vibration types (pulse versus continuous) to further its effectiveness by being able to apply different levels and types of vibrations to change things up in case the dog becomes accustomed to one type or level of vibration. Finally, the dog learns what behaviors are unacceptable to the handler and will stop such behaviors. For example, a dog that jumps on people is an unwanted behavior, the dog will learn very quickly that each time it jumps up on someone they get a vibration stimulus that instantly and instinctually makes them get back down on all four legs. They will learn not to jump on people. Other examples of undesirable behavior include leash pulling, biting, bullying, jumping, barking and digging. With this present disclosure the device is activated anytime the dog is pulling too hard on the leash, when the dog stops pulling the device is deactivated remotely. The dog learns the “sweet spot” where there is no vibration and in time will learn to stay in that area and not to pull on the leash while walking.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

It will be understood that, in general, terms used herein, and especially in the appended claims, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood that if a specific number of an introduced claim recitation is intended such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “an imager” should typically be interpreted to mean “at least one imager”); the same holds true for the use of definite articles used to introduce claim recitations. In addition, even if a specific number of an introduced claim recitation is explicitly recited, it will be recognized that such recitation should typically be interpreted to mean at least the recited number (e.g., the bare recitation of “two images,” or “a plurality of images,” without other modifiers, typically means at least two images). Furthermore, in those instances where a phrase such as “at least one of A, B, and C,” “at least one of A, B, or C,” or “an [item] selected from the group consisting of A, B, and C,” is used, in general such a construction is intended to be disjunctive (e.g., any of these phrases would include but not be limited to systems that have A alone, B alone, C alone, A and B together, A and C together, B and C together, or A, B, and C together, and may further include more than one of A, B, or C, such as A₁, A₂, and C together, A, B₁, B₂, C₁, and C₂ together, or B₁ and B₂ together). It will be further understood that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

While the invention has been described in terms of various specific embodiments, those skilled in the art will recognize that the invention can be practiced with modification within the spirit and scope of the claims.

What is claimed is:

1. A method for stimulus control of a dog utilizing operant conditioning which includes:
providing apparatus for selectively generating a vibration;
providing apparatus for positioning the apparatus for selectively generating a vibration against the dog's underbelly intermediate the front legs and the rear legs;
providing apparatus for selectively causing the apparatus for selectively generating a vibration to vibrate to stimulate the dog to stop selected undesirable behavior; and
preventing the apparatus from selectively generating a vibration when the dog is not behaving in an undesirable manner.

2. The method for stimulus control of a dog utilizing operant conditioning as described in claim 1 which includes behaviors selected from the group consisting of barking, chasing cars, leash pulling, biting, bullying, jumping, and digging.

3. The method for stimulus control of a dog utilizing operant conditioning as described in claim 1 wherein the step of providing apparatus for selectively causing the apparatus for selectively generating a vibration to vibrate to stimulate the dog to stop selected undesirable behavior includes a Bluetooth control.

4. The method for stimulus control of a dog utilizing operant conditioning as described in claim 1 wherein the step of providing apparatus for selectively causing the apparatus for selectively generating a vibration to vibrate to stimulate the dog to stop selected undesirable behavior includes a Wi-Fi control.

5. The method for stimulus control of a dog utilizing operant conditioning as described in claim 1 wherein the step of providing apparatus for positioning the apparatus for selectively generating a vibration against the dog's underbelly intermediate the front legs and the rear legs includes providing apparatus having selectively variable amplitude.

6. The method for stimulus control of a dog utilizing operant conditioning as described in claim 1 wherein the step of providing apparatus for positioning the apparatus for selectively generating a vibration against the dog's underbelly intermediate the front legs and the rear legs includes providing apparatus having selectively variable frequency.

7. The method for stimulus control of a dog utilizing operant conditioning as described in claim 1 wherein the step of providing apparatus for positioning the apparatus for selectively generating a vibration against the dog's underbelly intermediate the front legs and the rear legs includes providing apparatus having selectively variable acceleration.

8. The method for stimulus control of a dog utilizing operant conditioning as described in claim 1 wherein the step of providing apparatus for positioning the apparatus for selectively generating a vibration against the dog's underbelly intermediate the front legs and the rear legs includes providing apparatus having a vibration selected from the group consisting of continuous vibration and pulsed vibration.

9. The method as described in claim 1 wherein the step of providing apparatus for positioning the apparatus for selectively generating a vibration against the dog's underbelly intermediate the front legs and the rear legs includes providing a container for enclosing a vibrator that has at least a part thereof made of silicone to limit sliding on the body of the dog.
